(19) United States
(12) Patent Application Publication
(10) Pub. No.: US 2013/0274166 A1
(43) Pub. Date: Oct. 17, 2013

(54) NON-CORROSIVE STRIPPING COMPOSITIONS AND METHODS OF MAKING AND USING THE SAME

(71) Applicants: Carmine Savaglio, Kenosha, WI (US); Amy M. Sheppard, Union Grove, WI (US); Nathan E. Ludtke, Waterford, WI (US)

(72) Inventors: Carmine Savaglio, Kenosha, WI (US); Amy M. Sheppard, Union Grove, WI (US); Nathan E. Ludtke, Waterford, WI (US)

(73) Assignee: DIVERSEY, INC., Sturtevant, WI (US)

(21) Appl. No.: 13/978,286

(22) PCT Filed: Dec. 7, 2011
(86) PCT No.: PCT/US2011/063683

§ 371 Date: Jul. 3, 2013

Related U.S. Application Data
(60) Provisional application No. 61/430,323, filed on Jan. 6, 2011.

(51) Int. Cl. C09D 9/00

(52) U.S. Cl. CPC C09D 9/005
USPC 510/212

(57) ABSTRACT

Provided are compositions suitable for stripping coatings from a surface. The compositions may include a solvent and an organic functional amine. The solvent may be benzyl alcohol. The compositions may further include at least one chelant. The compositions may be non-corrosive to eyes or skin or both. Also provided are methods of stripping a coating from a surface, the method including applying to the surface a composition according to the disclosure.

### FIELD OF INVENTION

The present disclosure relates to non-corrosive compositions for stripping a coating from a surface.

### BACKGROUND

Coatings are often used to protect various surfaces from wear, staining, moisture, etching, etc. Examples of surfaces include, without limitation, floors, counters, walls, or other hard surfaces. The coatings may be removed for subsequent reapplication or other maintenance of the surface. Various compositions are available for stripping coatings from surfaces. Conventional stripping compositions may be expensive and difficult to use, include harsh chemicals, or function poorly at dilute concentrations. Conventional concentrated stripping compositions may include a high concentration of active agents that are diluted to suitable working concentrations at use. Conventional concentrated stripping compositions may also be corrosive and/or irritating to the user.

### SUMMARY

In one embodiment, provided are compositions suitable for stripping coatings from a surface. The compositions may comprise a solvent and an organic functional amine, wherein the composition has a pH of greater than about 10, and wherein the composition is non-corrosive to eyes or skin.

In other embodiments, provided are compositions suitable for stripping coatings from a surface. The compositions may comprise a solvent and an organic functional amine, wherein the composition has a pH of greater than 11.

In other embodiments, provided are compositions suitable for stripping coatings from a surface. The compositions may comprise a solvent, an organic functional amine, and 6-10% chelant.

In other embodiments, provided are methods of removing a coating from a surface, the methods comprising applying a composition comprising a solvent and an organic functional amine to the surface in an amount sufficient to remove the coating.

Other aspects of the invention will become apparent by consideration of the detailed description and accompanying drawings.

### BRIEF DESCRIPTION OF THE DRAWINGS

FIG. 1 is graph of stripping efficiency for Formulation 1 as compared to a conventional stripping composition.

FIG. 2 is a graph of the cycles needed to remove a coating from a surface for several floor finishes.

FIG. 3 is a graph of foam height for various floor stripping compositions.

### DETAILED DESCRIPTION

The present disclosure is not limited in its disclosure to the specific details of construction, arrangement of components, or method steps set forth herein. The compositions and methods disclosed herein are capable of being made, practiced, used, carried out and/or formed in various ways. The phraseology and terminology used herein is for the purpose of description only and should not be regarded as limiting. Ordinal indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention. The use herein of the terms “including,” “comprising,” or “having,” and variations thereof, is meant to encompass the items listed thereafter and equivalents thereof, as well as additional items. Unless specified or limited otherwise, the terms “mounted,” “connected,” “supported,” and “coupled” and variations thereof encompass both direct and indirect mountings, connections, supports, and couplings. Further, “connected” and “coupled” are not restricted to physical or mechanical connections or couplings.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein. All references cited herein are fully incorporated by reference, unless explicitly indicated otherwise. The present disclosure shall control in the event there are any disparities.

In some embodiments, the disclosure provides a composition for stripping a coating from a surface. The stripping compositions may comprise at least one of a solvent, an organic functional amine, a surfactant, a chelant, a buffer, water, and combinations thereof. In certain embodiments, the compositions may comprise a solvent. In certain embodiments, the compositions may comprise a solvent and an organic functional amine. In certain embodiments, the compositions may comprise a solvent, an organic functional amine, and a chelant. In certain embodiments, the compositions may comprise a solvent, an organic functional amine, a chelant, and a surfactant. In certain embodiments, the compositions may comprise a solvent, an organic functional amine, a chelant, a surfactant, and a buffer.

The solvent may comprise at least one of an alcohol, an ester, a phthalate-based solvent, a pyrrolidone-based solvent, and combinations thereof.

Examples of alcohols may include, but are not limited to, a polyhydric alcohols where the alcohol is an alkane polyol having 2 to 6 carbons and 2 to 3 hydroxyls in the molecule. Examples of polyhydric alcohols may include, but are not limited to, a ethylene glycol, propylene glycol, dipropylene glycol, glycerin, 1,2-butandediol, 1,3-butanediol, 1,4-butanediol, 1,4-butanediol, 2,3-butanediol, 1,2-propanediol, 1,5-pentanediol, meso-erythritol, neopentyl glycol, pentaerythritol, and combinations and blends thereof. Aromatic alcohol derivatives may also be useful. Examples of alcohols include, but are not limited to, a benzyl alcohol, xylenol, phenol, etc. Solvents may also include, but are not limited to, glycol ether based solvents based on ethylene or propylene glycol, diethylene glycol ethyl ether, dipropylene glycol methyl ether, diethylene glycol butyl ether, diethylene glycol monoethyl ether, ethylene glycol monohexyl ether (hexyl cellosolve), ethylene/diethylene glycol 2-ethylhexyl ether, ethylene glycol phenyl ether, dipropylene glycol propyl ether, dipropylene glycol butyl ether, propylene glycol phenyl ether, and blends thereof. Additionally, mono-alcohols such as methanol, ethanol, propanol, isopropanol, and butanol can be utilized in the solvent system. In certain embodiments, the solvent comprises benzyl alcohol.

Examples of esters in the solvent may include, but are not limited to, a glycol ether dibenzoates based on ethylene or propylene glycol including, but not limited, to propylene glycol dibenzoate, dipropylene glycol dibenzoate, polypropylene glycol diobenzoate, ethylene glycol dibenzoate, diethylene glycol dibenzoate, polyethylene glycol dibenzoate, neopentyl glycol dibenzoate, and the like as well as isodecyl benzoate, dipropylene glycol monomethyl ether benzoate, 2,2,4-trimethyl-1,3-pentanediol diisobutyrate and combinations thereof.

Examples of phthalate-based solvents in the solvent may include, but are not limited to, dibutyl phthalate, butyl benzyl phthalate, diethyl phthalate, and combinations thereof may also be used. Pyrollidone-based solvents may include, but are not limited to, 2-pyrollidone, N-methylpyrrolidone, N-octyl-2 pyrrolidone, and combinations thereof. Terpene derivatives are also suitable for use in the solvent system. Examples of terpenes include, but are not limited to, a cyclic terpenes such as D-limonene, pinene, etc. The solvent system may optionally include water.

The stripping composition may comprise solvent in an amount of at least about 1%, at least about 2%, at least about 4%, at least about 6%, at least about 8%, at least about 10%, at least about 12%, or at least about 15% by weight of the composition. The stripping composition may comprise solvent in an amount less than about 30%, less than about 28%, less than about 25%, less than about 23%, or less than about 20% by weight of the composition. This may include solvent in an amount of about 1-30%, about 5-25%, or about 10-20% by weight of the composition.

Surfactants may include, but are not limited to, at least one of amphoteric surfactants, anionic surfactants, nonionic surfactants, and combinations thereof. Amphoteric surfactants may include, but are not limited to, amine oxides such as C₈-C₂₀ amine oxides, betaines such as alkylamidopropylbetaine, alkyl dimethyl betaines (including MIRATAINE® JCHA from Rhodia, Cranbury, N.J.), sultaine, and alkylamino propionates.

Anionic surfactants may be water-soluble salts, particularly, alkali metal salts of organic sulfur reaction products having in their molecular structure an alkyl radical containing from about 8 to about 22 carbon atoms and a radical selected from the group consisting of sulfamic acid and sulfuric acid ester radicals. Such surfactants are well known in the art and are described at length in “Surface Active Agents and Detergents”, Vol. II by Schwartz, Perry and Berch, Interscience Publishers Inc., 1958, incorporated by reference herein. Examples of anionic surfactants include, but are not limited to, amides, sulfosuccinates and derivatives, sulfates of ethoxylated alcohols, sulfates of alcohols, sulfonates and sulfonic acid derivatives, phosphate esters, and polymeric surfactants. Examples of anionic surfactants may include, but are not limited to, alkyl sulfate, ether sulfate, alkyl sulfonate, alkyl benzene sulfonate, alpha olefin sulfonate, diphenyloxide disulfonate, alkyl naphthalene sulfonate, sulfosuccinate, sulfosuccinamate, naphthalene-formaldehyde condensate, isethionate, N-methyl taurate, phosphate ester, and ether carboxylate. Examples of anionic surfactants include a alkyl diphenyloxide disulfonates. Other examples of anionic surfactants may include, but are not limited to, Dowfax 2A-1, Dowfax 38-2, and Dowfax C10L (Dow, Midland, Mich.); Calsoft AOS-40 sodium alpha olefin sulfonate and Calsoft LAS-99 linear alkylbenzene sulfonic acid (Pilot Chemical, Cincinnati, Ohio); and Steol CA-460 alkyl ether sulfate ammonium salt and Steol CS-460 sodium laureth sulfate (Stepan Company, Northfield, Ill.).

Nonionic surfactants may include, but are not limited to, compounds produced by the condensation of alkylene oxide groups (hydrophilic in nature) with an organic hydrophobic compound, which may be aliphatic or alkyl aromatic in nature. The length of the hydrophilic or polyoxy alkylene radical which is condensed with any particular hydrophobic group can be readily adjusted to yield a water-soluble compound having the desired degree of balance between hydrophilic and hydrophobic elements. Examples of nonionic surfactants include, but are not limited to, alkanolamides, amine oxides, block polymers, ethoxylated primary and secondary alcohols, ethoxylated alkylphenols, ethoxylated fatty esters, sorbitan derivatives, glycerol esters, propoxylated and ethoxylated fatty acids, alcohols, and alkyl phenols, glycol esters, polymeric polysaccharides, sulfates and sulfonates of ethoxylated alkylphenols, and polymeric surfactants.

Nonionic surfactants are conventionally produced by condensing ethylene oxide with a hydrocarbon having a reactive hydrogen atom, e.g., a hydroxyl, carboxyl, amino, or amido group, in the presence of an acidic or basic catalyst. Nonionic surfactants may have the general formula RA(CH₂CH₂O)ₙH wherein R represents the hydrophobic moiety, A represents the group carrying the reactive hydrogen atom and n represents the average number of ethylene oxide moieties. R may be a primary or a secondary, straight or slightly branched, aliphatic alcohol having from about 8 to about 24 carbon atoms. Additional examples of nonionic surfactants can be found in U.S. Pat. No. 4,111,855, Barrat, et al., issued Sep. 5, 1978, and U.S. Pat. No. 4,865,773, Kim et al., issued Sep. 12, 1989, which are hereby fully incorporated by reference.

Other nonionic surfactants useful in the composition include ethoxylated alcohols or ethoxylated alkyl phenols of the formula R(OC₂H₄)ₙOH, wherein R is an aliphatic hydrocarbon radical containing from about 8 to about 18 carbon atoms or an alkyl phenyl radical in which the alkyl group contains from about 8 to about 15 carbon atoms, and n is from about 2 to about 14. Examples of such surfactants are listed in U.S. Pat. No. 3,717,630, Booth, issued Feb. 20, 1973, U.S. Pat. No. 3,332,880, Kessler et al., issued Jul. 25, 1967, and U.S. Pat. No. 4,284,435, Fox, issued Aug. 18, 1981, which are hereby fully incorporated by reference.

Moreover, other nonionic surfactants include the condensation products of alkyl phenols having an alkyl group containing from about 8 to about 15 carbon atoms in either a straight chain or branched chain configuration with ethylene oxide, said ethylene oxide being present in an amount from about 2 to about 14 moles of ethylene oxide per mole of alkyl phenol. The alkyl substituent in such compounds can be derived, for example, from polymerized propylene, diisobutylene, and the like. Examples of compounds of this type include nonyl phenol condensed with about 9 moles of ethylene oxide per mole of nonyl phenol, dodecyl phenol condensed with about 8 moles of ethylene oxide per mole of phenol, and the commercially available T-DET® 9.5 marketed by Harcros Chemicals Incorporated.

Other nonionic surfactants useful in the composition include fatty acid salts. Fatty acid salts include, but are not limited to, salts of coco fatty acid (coconut oil fatty acid), salts of tall oil fatty acid, salts of oleic acid, and salts of C₈-C₂₀ fatty acids.

Other useful nonionic surfactants are the condensation products of aliphatic alcohols with from about 2 to about 14 moles of ethylene oxide. The alkyl chain of the aliphatic alcohol can either be straight or branched, primary or secondary, and may contain from about 8 to about 18 carbon atoms. Examples of such ethoxylated alcohols include secondary alcohol nonionic surfactants such as ENS-70, the condensation product of myristyl alcohol condensed with about 9 moles of ethylene oxide per mole of alcohol, and the condensation product of about 7 moles of ethylene oxide with coconut alcohol (a mixture of fatty alcohols with alkyl chains varying in length from 10 to 14 carbon atoms). Examples of commercially available nonionic surfactants in this type include: Tergitol™ 15-S-7 or 15-S-9 marketed by Union Carbide Corporation; Neodol™ 45-9, Neodol™ 23-6.5, Neodol™ 45-7 and Neodol™ 45-4 marketed by Shell Chemical Company; Kyro EOB marketed by The Procter & Gamble Company; and Berol® 260 and Berol® 266 marketed by Akzo Nobel. Other suitable non-ionic surfactants include Neodol™ ethoxylates, commercially available from Shell Chemicals (Houston, Tex.) and Tergitol™ surfactants, commercially available from Dow (Midland, Mich.). Additional nonionic surfactants may be selected from the class of fluorinated materials, such Zonyl, FSJ, Zonyl FSN, etc., commercially available from DuPont. Suitable nonionic surfactants may include primary and secondary alcohol ethoxylates and alkyl polyglucosides. Primary alcohol ethoxylates may include C9-C11 primary alcohol ethoxylates such as Tomadol® 91-2.5, Tomadol® 91-6, and Tomadol® 91-8. Secondary alcohol ethoxylates may include C12-C14 secondary alcohol ethoxylates such as Tergitol® 15-S-3, Tergitol® 15-S-7, and Tergitol® 15-S-9. Tergitol® is a trademark of Union Carbide Corporation for C8-C18 non-ionic surfactants with 1-15 moles of ethylene oxide. Alkyl polyglucosides may include C8-C16 alkyl polyglucosides such as Glucopon® 625FE, Glucopon® 425N, and Triton™ BG-10. A mixture of nonionic surfactants may also be used. Examples of specific nonionic surfactants further include but are not limited to Caloxamine LO lauryl dimethylamine oxide (Pilot Chemical, Cincinnati, Ohio).

The stripping composition may comprise surfactant in an amount of at least about 0.5%, at least about 1%, at least about 2%, or at least about 3% by weight of the composition. The stripping composition may comprise surfactant in an amount of less than about 8%, less than about 7%, less than about %, less than about 5%, or less than about 4% by weight of the composition. This may include surfactant in an amount of about 0-8%, about 1-7%, about 2-5%, or about 4-7% by weight of the composition.

Organic functional amines generally include at least an organic group and an amine. Examples may include, but are not limited to, monoethanolamine (MEA), diethanolamine (DEA), triethanolamine (TEA), monoisopropanolamine, n-alkyl substituted derivatives thereof, or combinations thereof. The organic functional amine may be monoethanolamine.

The stripping composition may comprise organic functional amine in an amount of at least about 1%, at least about 2%, at least about 4%, at least about 6%, at least about 8%, or at least about 10% by weight of the composition. The stripping composition may comprise organic functional amine in an amount of less than about 25%, less than about 23%, less than about 20%, less than about 18%, or less than about 15% by weight of the composition. This may include organic functional amine in an amount of about 1-25%, about 2-20%, or about 5-15% by weight of the composition.

The compositions may further comprise at least one chelant. Examples of chelants may include, but are not limited to, ethylenediaminetetraacetic acid (EDTA), hydroxyethylethylenediaminetriacetic acid (HEDTA), penicillamine, 2,3-dimercapto-1-propanesulfonic acid (DMPS), dimercaptosuccinic acid (DMSA), gluconic acid, acrylic acid, nitrilotriacetic acid (NTA), glutamic acid diacetic acid (GLDA; DISSOLVINE® GL from AkzoNobel, Chicago, Ill.), tetrasodium iminodisuccinate, iminosuccinic acid, pentasodium diethylenetriamine pentacetate, and polyaspartate. The chelant may be EDTA.

The composition may comprise chelant in an amount of at least about 1%, at least about 2%, at least about 3%, at least about 4%, or at least about 5% weight of the composition. The composition may comprise chelant in an amount of less than about 10%, less than about 9%, less than about 8%, less than about 7%, or less than about 6% by weight of the composition. This may include chelant in an amount of about 1-10%, about 2-8%, about 3-6%, or about 6-10% by weight of the composition.

The compositions may further comprise a buffer. Examples of buffers may include, but are not limited to, coco fatty acid (coconut oil fatty acid), tall oil fatty acid, phosphoric acid, acetic acid, citric acid, glycolic acid, oleic acid, and C₈-C₂₀ fatty acids. In certain embodiments, the buffer is coco fatty acid.

The composition may comprise buffer in an amount of at least about 0.5%, at least about 1%, at least about 2%, at least about 3%, at least about 4%, or at least about 5% by weight of the composition. The composition may comprise buffer in an amount of less than about 10%, less than about 9%, less than about 8%, less than about 7%, or less than about 6% by weight of the composition. This may include buffer in an amount of about 0-10%, about 0.5-10%, or about 1-8% by weight of the composition.

The compositions may further comprise a coupling agent. A coupling agent may aid in stabilization of the composition, such as maintaining shelf life. Examples of coupling agents may include, but are not limited to, sodium xylene sulfonate (SXS), sodium cumene sulfonate (SCS), and ethyl hexyl sulfonate (EHS). In certain embodiments, the coupling agent is sodium xylene sulfonate.

The composition may comprise coupling agent in an amount of at least about 0.5%, at least about 1%, at least about 2%, at least about 3%, at least about 4%, or at least about 5% by weight of the composition. The composition may comprise coupling agent in an amount of less than about 10%, less than about 9%, less than about 8%, less than about 7%, or less than about 6% by weight of the composition. This may include coupling agent in an amount of about 0-10%, about 0.5-10%, or about 3-8% by weight of the composition.

The balance of the composition may be water. For example, the composition may comprise water in an amount of at least about 0%, at least about 10%, at least about 20%, at least about 30%, or at least about 40% by weight of the composition. The composition may comprise water in an amount of less than about 99%, less than about 90%, less than about 80%, less than about 70%, or less than about 60% by weight of the composition. This may include water in an amount of about 0-99%, about 10-95%, about 20-90%, about 30-80%, or about 40-60% by weight of the composition.

The compositions may have a basic pH. The pH may be at least about 10, at least about 10.1, at least about 10.2, at least about 10.3, at least about 10.4, at least about 10.5, at least about 10.6, at least about 10.7, at least about 10.8, at least about 10.9, at least about 11.0, at least about 11.1, at least about 11.2, at least about 11.3, at least about 11.4, at least about 11.5, or at least about 11.6. The pH may be less than about 13.0, less than about 12.9, less than about 12.8, less than about 12.7, less than about 12.6, less than about 12.5, less than about 12.4, less than about 12.3, less than about 12.2, less than about 12.1, or less than about 12.0. This may include a pH of about 10-13, about 10-12, or about 11-12.

The compositions may have a viscosity of at least about 2, at least about 2.5, at least about 3, at least about 3.5, or at least about 4. The compositions may have a viscosity of less than about 7, less than about 6.5, less than about 6, less than about 5.5, or less than about 5. This may include a viscosity of about 2-7, about 3-5, or about 4-5.

The compositions may have a weight per gallon of at least about 8, at least about 8.1, at least about 8.2, at least about 8.3, at least about 8.4 or at least about 8.5 pounds/gallon. The compositions may have a weight per gallon of less than about 10, less than about 9.9, less than about 9.8, less than about 9.7, less than about 9.6, less than about 9.5, less than about 9.4, less than about less than 9.3, less than about 9.2, less than about 9.1, or less than about 9 pounds/gallon. This may include a weight per gallon of about 8-10, about 8.5-9.5, or about 8-9 pounds/gallon.

The compositions may have a high pH but may be surprisingly non-corrosive. The compositions may be non-corrosive to eyes, skin, or both. Non-corrosive to the eye refers to a composition with an Eye Irritation GHS Classification of Category 2A or 2B or non-classified, i.e., no worse than Category 2A, when the composition is tested via the Bovine Corneal Opacity and Permeability (BCOP) test. A non-irritant to the eye refers to a composition with an Eye Irritation GHS Classification of non-classified. Non-corrosive to the skin refers to a composition with a Skin Irritation GHS Classification of Category of 2 or 3 or non-classified, i.e., no worse than Category 2, when the composition is tested via OECD Test No. 404. A non-irritant to the skin refers to a composition with a Skin Irritation GHS Classification of non-classified. The compositions in concentrated form (as set forth above) or in diluted form (as discussed in more detail below) may be non-corrosive. GHS Classifications may be determined as in Example 6 and Example 7. GHS Classification Categories are shown in Table 1.

The compositions may have an eye in vitro score of less than 75, less than 70, less than 65, less than 60, less than 55, less than 50, less than 45, less than 40, less than 35, less than 30, less than 25, less than 20, less than 15, less than 10, or less than 5, according to the BCOP identified in Example 7 below.

TABLE 1
GHS Classification Categories.
Skin Corrosion

| Category 1A | Category 1B | Category 1C |
|---|---|---|
| Destruction of skin tissue | Destruction of skin tissue | Destruction of skin tissue |
| upon exposure of up to 3 min. | upon exposure of up to 1 h. | upon exposure of up to 4 h. |
| Causes severe skin burns | Causes severe skin burns | Causes severe skin burns |
| and eye damage. | and eye damage. | and eye damage. |

Skin Irritation

| Category 2 | Category 3 |
|---|---|
| Draize score mean value of ≧2.3 > 4.0 for | Draize score mean value of ≧1.5 < 2.3 for |
| erythema/eschar or edema in at least 2 of 3 | erythema/eschar or edema in at least 2 of 3 |
| tested animals from gradings at 24, 48, and 72 | tested animals from gradings at 24, 48, and 72 |
| hours (or on 3 consecutive days after onset if | hours (or on 3 consecutive days after onset if |
| reactions are delayed); inflammation that | reactions are delayed). |
| persists to end of the (normally 14-day) | Causes mild skin irritation. |
| observation period. | |
| Causes skin irritation. | |

Eye Irritation

| Category 1 | Category 2A | Category 2B |
|---|---|---|
| Effects on the cornea, iris or | Effects on the cornea, iris or | Effects on the cornea, iris or |
| conjunctiva that are not | conjunctiva that fully reverse | conjunctiva that fully reverse |
| expected to reverse or that | within 21 days. | within 7 days. |
| have not fully reversed within | Causes severe eye irritation. | Causes eye irritation. |
| 21 days. | | |
| Causes severe eye damage. | | |

The compositions may be diluted in hard water and still be efficacious and stable. As used herein, hard water may include at least about 200 ppm, at least about 250 ppm, at least about 300 ppm, at least about 350 ppm, or at least about 400 ppm of CaCO₃.

The compositions may also have low foaming properties. Low foam compositions may be analyzed by determining the foam height of the composition, e.g, as described in Example 3. Briefly, a volume of composition is added to a container such as a graduated cylinder. The container is closed, such as with a stopper, before being inverted, for example, ten times. The height of the resulting foam initially (immediately after inversion) as well as at other time points in time after inversion may be compared. As used herein, “low foam” is comparatively lower foam height. For 50 mL of liquid composition placed in a graduated cylinder and inverted ten times, the following classification of foam height may be used, wherein foam height is height of the liquid plus height of the foam in mL:

foam height of 150+ mL=high foam

foam height of 100-150 mL=moderate foam

foam height of 75-100 mL=low foam

foam height of 50-75 mL=very low foam

The compositions may be stable with a low cloud point. The compositions may remain clear and stable with no sediment present, as detailed in Example 4. The compositions may be clear after incubation at 120° F. or 40° F. for a period of time. For example, the compositions may be clear after incubation at about 120° F. for at least about 8 h, at least about 12 h, at least about 24 h, at least about 48 h, at least about 1 week, at least about 2 weeks, at least about 3 weeks, at least about 4 weeks, at least about 1 month, at least about 2 months, at least about 3 months, at least about 6 months, or at least about 1 year. The compositions may be clear and stable with no sediment after incubation at about 40° F. for at least about 8 h, at least about 12 h, at least about 24 h, at least about 48 h, at least about 1 week, at least about 2 weeks, at least about 3 weeks, at least about 4 weeks, at least about 1 month, at least about 2 months, at least about 3 months, at least about 6 months, or at least about 1 year.

The components of the compositions may be combined and mixed in any order using conventional mixing methods. Examples of conventional mixing methods include, but are not limited to, placing in a container such as a beaker or Erlenmeyer flask with a magnetic stirrer, or mixing in a container with an overhead mixed or lab stirrer (for example, Yamato LR400c from Yamato Scientific America Inc., Santa Clara, Calif.) at about 150 to about 400 rpm, or at about 200 to about 300 rpm. The components may be mixed together until homogenous. The components may be mixed cold, without the addition of heat.

In other embodiments, provided are methods of removing a finish or coating from a surface. Further provided are methods of stripping a finish or coating from a surface. Methods may comprise applying a composition as described above to the surface. The composition may be applied to the surface in an amount sufficient to remove the finish or coating. The composition may be applied to a finish or coating at least partially on the surface.

The coating removal compositions may be applied to surfaces, such as coated substrates to be stripped, and the composition may be allowed to contact the coating or the surface or both. Surfaces may include, but are not limited to, floors, counters, walls, or other hard surfaces. The surface may comprise materials including, but not limited to, vinyl, ceramics, marble, terrazzo, linoleum, concrete, rubber, granite, or combinations thereof. Coatings which may be stripped using the stripping compositions include at least one of compositions comprising paint, resin, epoxy, lacquer, sealant, finish, other coatings and combinations thereof. Examples of coating materials include, but are not limited to, urethane, acrylic, polymer, grease, wax, oil, or combinations thereof. Examples of finishes include, without limitation, FRESCO MAX™, CAREFREE® MATTE, VECTRA™, PREMIA™, and SIGNATURE™ s.8 (all from Diversey, Inc., Sturtevant, Wis.). Coatings may include a single layer or multiple layers of the same or different compositions.

The stripping compositions may be applied to at least one of the surface, the coating, and both for a period of contact time (e.g., about 0 to about 10 to about 30 min) before removing the coating. Applying may include any number of techniques including, but not limited to, mopping, pouring, spraying, sprinkling, brushing, immersing, dispensing from a suitable dispenser, etc. Among other things, pads, sponges, three-dimensional non-woven pads, natural or synthetic fiber-based cloths or mops, and other fabrics may be used to apply the stripping compositions or remove the coatings. Additionally, mopping, spraying, abrading, vigorous agitating, applying friction, applying pressure, using automatic scrubbers, vacuuming, flushing with water, etc. may be used to remove the coatings after application of the stripping compositions. The material may be attached to a conventional floor maintenance machine including, but not limited to, swing machines from manufacturers such as TASKI (e.g., TASKI Ergodisc 200), Tennant, and Clarke, and auto-scrubbers from manufacturers such as TASKI, Tennant, Clarke, and TomKat (e.g., TomKat Magnum—26 inch).

The compositions may effectively remove at least one coating from a surface when diluted to less than about 1:10, less than about 1:9, less than about 1:8, less than about 1:7, less than about 1:6, or less than about 1:5. The compositions may effectively remove at least one coating from a surface when diluted to at least about 1:1.5, at least about 1:2, or at least about 1:3. This may include dilutions of about 1:1.5 to about 1:10, about 1:2 to about 1:8, or about 1:3 to about 1:6.

### EXAMPLES

The following examples are provided to assist in further understanding of the invention. The particular materials and methods employed are considered to be illustrative of the invention and are not meant to be limiting on the scope of the claims.

### Example 1

### Non-Corrosive Stripping Compositions

Compositions were prepared according to Table 2. The formulations in Table 2 are concentrated compositions, which may be diluted, for example, to 1:4 for use.

TABLE 2
Non-corrosive stripping compositions.

| | Formulation | | | | | |
|---|---|---|---|---|---|---|
| | #1 | #2 | #3 | #4 | #5 | #6 |
| Component | wt % | wt % | wt % | wt % | wt % | wt % |
| benzyl alcohol | 13.5 | 13.5 | 9.0 | 9.0 | 47.0 | 46.0 |
| monoethanolamine | 7.5 | 6.0 | 2.0 | 2.0 | 42.0 | 40.0 |
| diethylene glycol | 5.0 | 5.0 | 5.0 | 5.0 | — | — |
| monoethyl ether | | | | | | |
| (DE carbitol) | | | | | | |
| hexyl cellosolve EH | 1.0 | 1.0 | 1.0 | 1.0 | — | — |
| EDTA NA₄ | 5.0 | 5.0 | 5.0 | 5.0 | — | — |
| iminosuccinic acid, | 5.0 | 5.0 | 5.0 | 5.0 | — | — |
| sodium salt | | | | | | |
| (Baypure CX 100/34%) | | | | | | |
| pentasodium | 2.0 | 2.0 | 2.0 | 2.0 | — | — |
| diethylenetriamine | | | | | | |
| pentacetate | | | | | | |
| (Versenex 80) | | | | | | |
| sodium xylene | 11.0 | 11.0 | 14.0 | 14.0 | — | — |
| sulfonate 40% | | | | | | |
| (SXS-40) | | | | | | |
| Dowfax 2a-1 | 0.5 | 0.5 | 1.0 | 1.0 | — | — |
| coconut fatty acid | 1.0 | 1.0 | — | — | — | — |
| (Emery 622) | | | | | | |
| glycerine | — | — | — | 3.0 | — | 3.0 |
| Tergitol 15-S-7 | — | — | — | — | 2.0 | 2.0 |
| (alcohol ethoxylate) | | | | | | |
| alkyl polyglucoside | — | — | — | — | — | 6.0 |
| (APG 425N) | | | | | | |
| Water, deionized | 48.5 | 50.0 | 56.0 | 53.0 | 3.0 | 3.0 |
| TOTAL | 100% | 100% | 100% | 100% | 100% | 100% |

### Example 2

### Stripping Efficiency

A stripped VCT tile was coated with ten coats of desired floor finish or sealer (FRESCO MAX™, CAREFREE® MATTE, VECTRA™, PREMIA™, or SIGNATURE™ s.8 all from Diversey, Inc., Sturtevant, Wis.). VCT tiles are vinyl composition tiles manufactured by, for example, Tarkett (Nanterre, France), Armstrong (Lancaster, Pa.), and Azrock (Houston, Tex.). Each coat was numbered with a grease pencil, wherein “10” was marked under the 10^{th} coat, “9” was marked under the 9^{th} coat, etc. The tile was then baked in an oven at 120° F. for four days. After baking the tile was cut into 2-inch strips. The tile was placed into Byk-Gardner Scrubber (Byk-Gardner, Columbia, Md.). Formulation 1 (Example 1) was diluted with water to 1:2, 1:4, 1:6, and 1:8 dilutions. Then 50 mL of each dilution was placed on the tile strip. The Byk-Gardner Scrubber, with a red pad attached (3M™ Red Buffer Pad 5100 from 3M, St. Paul, Minn.), was started on the tile. The number of cycles necessary to remove each respective coat was monitored and recorded. Complete removal of a layer was determined once the next layer's number in grease pencil was completely gone. For comparison, the process was repeated for BRAVO™ 1500+ stripping composition (Diversey, Inc., Sturtevant, Wis.).

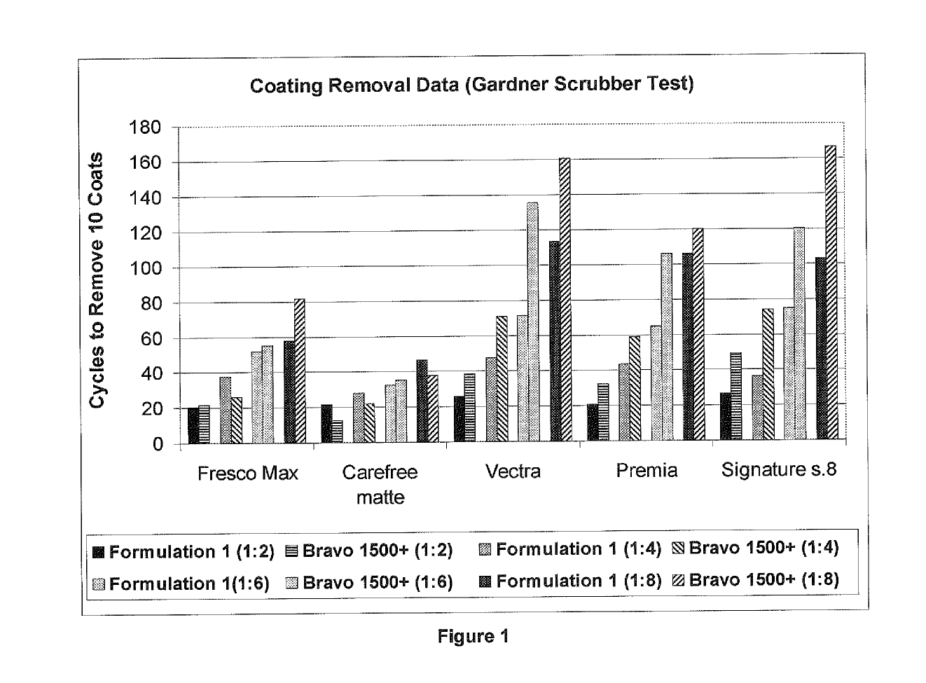

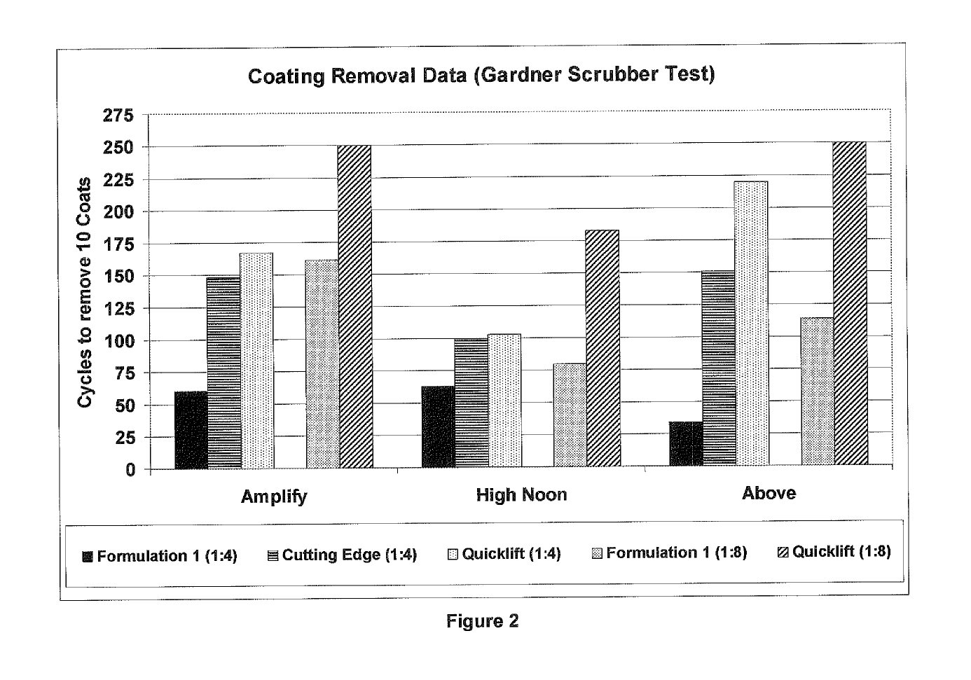

Results are shown in FIG. 1 and FIG. 2. The data set clearly shows that Formulation 1 performed equally or better than Bravo 1500+ (Diversey, Inc., Sturtevant, Wis.) on most of the finishes except for Fresco Max. Also, there was a decrease in performance for both stripper compositions tested once dilutions begin to exceed a 1:6 dilution. The same trend was observed with Formulation 1 and BUTCHERS® CUTTING EDGE™ and QUICKLIFT (both from Diversey, Inc., Sturtevant, Wis.).

### Example 3

### Foam Height

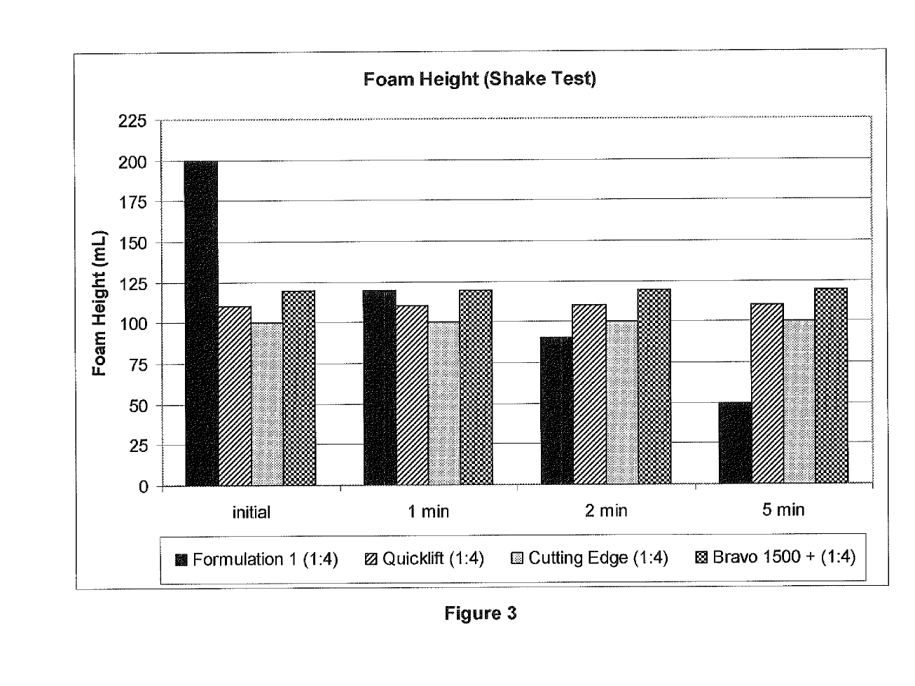

Formulation 1 (Example 1) was diluted to 1:4. 50 mL of each dilution was placed into a 250 mL graduated cylinder. A stopper was placed on top of the cylinder, and the cylinder was inverted ten times. The foam height, measured in mL, was the height of the foam and liquid. The initial foam height was recorded, as well as the foam height after 1 min, 2 min, and 5 min of sitting. For comparison, the process was repeated with QUICKLIFT, BUTCHERS® CUTTING EDGE™, and BRAVO™ 1500+ (all from Diversey, Inc., Sturtevant, Wis.) stripping compositions. Results are presented in Table 3 and FIG. 3.

TABLE 3
Foam height data.

| Sample | initial | 1 min | 2 min | 5 min |
|---|---|---|---|---|
| Formulation 1 (1:4) | 200 | 120 | 90 | 50 |
| QUICKLIFT (1:4) | 110 | 110 | 110 | 110 |
| CUTTING EDGE ™ (1:4) | 100 | 100 | 100 | 100 |
| BRAVO ™ 1500+ (1:4) | 120 | 120 | 120 | 120 |

The results indicated that all commercial strippers had a relatively low foam profile when compared to each other. The foam was also very stable; this could lead to build-up over a large area and cause premature shut down of the auto-scrubber. Formulation 1 had relatively high foam initially, but it had a rapid defoaming action. Foam was barely visible after 3 min. The low-foam property of Formulation 1 was confirmed in the field in auto-scrubber tanks of W92-1, wherein a very small foam head was shown after completion of a stripping cycle.

### Example 4

### Cloud Point Evaluation

Cloud point was determined for the compositions as an indicator of the stability of formation. 200 g of Formulation 1 (Example 1) without dilution was placed into two PETE bottles. One bottle was placed in an oven at 120° F. overnight, and the other bottle was placed in a refrigerator at 40° F. overnight. The composition in the bottles was then observed for cloudiness and phase separation. The bottles were kept at 120° F. and 40° F. for one month, and the composition in the bottles was observed again for cloudiness and phase separation. For comparison, the process was repeated with BRAVO™ 1500+ stripping composition (Diversey, Inc., Sturtevant, Wis.). Results are presented in Table 4. Formulation 1 was clear and stable with no sediment present at both the overnight and one-month time points.

TABLE 4
Cloud Point.

| | | |
|---|---|---|
| Product | Cold 40° F. | Hot 120° F. |

Cloud Point Appearance: Overnight

| | | |
|---|---|---|
| Formulation 1 | clear, stable, no sediment | clear, stable, no sediment |
| BRAVO ™ | clear, stable, no sediment | clear, stable, no sediment |
| 1500+ | | |

Stability: Cloud Point Appearance after One Month

| | | |
|---|---|---|
| Formulation 1 | clear, stable, no sediment | clear, stable, no sediment |
| BRAVO ™ | clear, stable, no sediment | dear, stable, no sediment |
| 1500+ | | |

### Example 5

### Hard Water Stability

Formulation 1 (Example 1) was diluted to 1:4 using 300 ppm hard water. The hard water was prepared by dissolving 1 g of CaCO₃ in 1000 g of deionized water to make a 1000 ppm solution of CaCO₃. Then, 1200 mL of the 1000 ppm solution of CaCO₃ was diluted with 2800 mL of deionized water in a 4000 mL beaker, to yield a 300 ppm solution of CaCO₃. The dilution was observed for appearance, haze, flocculation, and phase separation. The process was repeated BRAVO™ 1500+ and QUICKLIFT (both from Diversey, Inc., Sturtevant, Wis.) stripping compositions for comparison. If no precipitate formed (solution was clear), the solution was classified as stable. A cloudy or hazy appearance was classified as less stable but functional. Results are shown in Table 5. The compositions were clear and presented no problems with hard water.

TABLE 5
Hard Water Stability
Dilution Appearance with 300 ppm water, 70° F. and 50% RH

| Product | Appearance |
|---|---|
| Formulation 1 (1:4) | clear, no issues |
| BRAVO ™ 1500+ (1:4) | clear, no issues |
| QUICKLIFT (1:4) | clear, no issues |

### Example 6

### Skin Irritation Testing

Formulation 1 and Formulation 3 were tested for in viva skin corrosiveness according to Organization for Economic Cooperation and Development (OECD) Test No. 404. The results were interpreted using the classifications according to GHS standards (Globally Harmonized System of Classification and Labelling of Chemicals).

After 3 min exposure with Formulation 1, no erythema was observed 60 min past patch removal. After 1 h exposure with Formulation 1, no erythema was observed 60 min past patch removal. Three rabbits were then exposed to Formulation 1 for 4 h. After 4 h of exposure, all sites were clear by day 14, on which day minimal flaking was still observed in ⅔ animals. Edema was absent after 24 h. PII was calculated to be 1.83. Formulation 1 was not corrosive at any time point.

Formulation 3 was only tested at the 4 h time point. Three rabbits were exposed to Formulation 3 for 4 h. After 4 h exposure, no erythema or edema was observed on any animal. PII was calculated to be 0. Formulation 3 was not corrosive at any time point.

Formulation 1 was classified as a Skin Irritation GHS Classification of Category 3-Mild Irritant. Based on the limited data in the study, Formulation 3 would not be classified according to GHS, that is, it did not cause skin irritation.

### Example 7

### Eye Irritation Testing

A Background Review Document (BRD) proposed a non-animal assessment for evaluating the eye irritation potential of antimicrobial cleaning products and determining the appropriate precautionary labeling, and it was submitted to the U.S. EPA and ICCVAM by the Institute for In Vitro Sciences (Curren et al., The Background Review Document of an In Vitro Approach for EPA Toxicity Labeling of Antimicrobial Cleaning Products, July 2008, incorporated herein by reference in its entirety). This in vitro strategy is conservative and results in over-labeling of some products. According to the BCD, compositions are tested with the Bovine Corneal Opacity and Permeability Test (BCOP), followed by a histopathological evaluation. Further, the BRD proposes that any formulation containing greater than 5% solvent should be tested with a 3 min exposure time. Accordingly, Formulation 1 and Formulation 2 were tested for eye irritation using the BCOP at 3 min exposure, followed by histopathological evaluation. SPITFIRE® SC (from Diversey, Inc., Sturtevant, Wis.) was used for comparison, as it had previously documented in vivo testing.

BCOP Procedure

The BCOP protocol used was based on the methodology described in Gautheron, P., et al. “Bovine Corneal Opacity and Permeability Test: An In-Vitro Assay of Ocular Irritancy” Fundamental and Applied Toxicology, 1992, 18, 442-449, which is incorporated herein by reference in its entirety.

Bovine eyes were received from Spear Products (Coopersburg, Pa.) and transported in Hank's Balanced Salt Solution (HBSS) in a refrigerated container. Solutions were made fresh prior to use. Minimum Essential Media (MEM) solution was prepared by stirring together one jar of MEM powder for 1 L of solution, 2.2 g sodium bicarbonate, 0.292 g L-Glutamine, 10 mL fetal bovine serum (FBS), and 1000 mL distilled water. MEM solution was kept in an incubator for the duration of the testing. HBSS was prepared by mixing HBSS powder for 1 L of solution, 0.35 g sodium bicarbonate, and 1000 mL distilled water. HESS was maintained at room temperature.

The bovine eyes were examined within one hour after receipt. Any eye with a cornea exhibiting evidence of vascularization, pigmentation, opacity, or scratches was discarded. Corneas that were free of defects were dissected from the surrounding tissues. A 2-3 mm rim of sclera was left attached to each cornea. The corneas were then placed in a container of fresh HBSS. The dissected corneas were mounted in holders that were separated into anterior and posterior chambers and filled separately. Each cornea was mounted allowing the epithelium of the cornea to project into the anterior chamber. The posterior chamber was filled with MEM solution to ensure contact with the endothelium. The anterior chamber was filled with MEM solution to ensure contact with the epithelium. Each cornea was visually inspected again to ensure there were no defects. The entire holder with the cornea was then incubated at 32° C. (±2° C.) and allowed to equilibrate for at least one hour but less than 2 hours. Following the equilibration, the holders containing the corneas were removed from the incubator. The MEM solution was removed from both chambers, and the chambers were refilled with fresh MEM solution. At this time, five corneas were selected for dosing with Formulation 1 and two were selected as controls. A pre-exposure determination of opacity was made for each control by measuring each against the blanks supplied by the opacitometer. A pre-exposure determination of opacity was made for each test cornea by measuring against each control cornea (for a total of 10 determinations).

Following the pre-test observations, the MEM solution was removed from the anterior chamber and a volume of 0.75 mL of Formulation 1 was applied to the epithelium of each of the five treated corneas. The holders and corneas were placed in a horizontal position in the 32° C. (±2° C.) incubator to ensure contact of Formulation 1 with the corneas. After 3 (±1) min, Formulation 1 (or MEM solution for the controls) was removed from the epithelium of the cornea and anterior chamber of the holder by washing with MEM solution. The anterior and posterior chambers of the holders were then refilled with fresh MEM solution, and opacity measurements were taken.

All corneas were incubated for an additional 2 h period, after which the MEM solution in the anterior and posterior chambers was removed and the holders were refilled with fresh MEM solution. A measurement of opacity was taken with each treated cornea compared to each of the two control corneas. Opacity measurement of the cornea was made using an OP-KIT opacitometer (Electro-Design, Riom, France).

Immediately following the 2 h opacity measurement, the MEM solution was removed from the anterior chamber and replaced with 1.0 mL of 0.4% sodium fluorescein solution in Dulbecco's Phosphate Buffered Saline (DPBS). Each holder was then returned to the 32° C. (±2° C.) incubator in a horizontal position to ensure contact of the fluorescein with the cornea. After 90 min, the fluid from the posterior chamber was removed. The amount of dye that passes through the cornea was measured as optical density at 490 nm by spectrophotometer analysis. Following the optical density measurement, the treated and control corneas were removed from the chambers and fixed in 10% neutral buffered formalin. The fixed corneas were sent for histologic preservation and subsequent pathologic evaluation.

Analysis of Data

The Corrected Mean Opacity Score was calculated using the control and treated cornea opacity values as determined from the OP-KIT. The corrected Mean Optical Density Score was calculated using the control and treated Optical Density values from the fluorescein permeability analysis. The in vitro score was calculated as the following:

In vitro score=Corrected Mean Opacity Score+15(Corrected Mean Optical Density Score)

The in vitro scores were interpreted as follows: in vitro score of 0 to 25=mild irritant; in vitro score of 25.1 to 55=moderate irritant; and in vitro score of 55.1 to greater than or equal to 75=severe irritant. According to the BRD, an in vitro score greater than 75 may be corrosive, and histo-pathological evaluation should be conducted to determine whether or not there are irreversible effects.

In Vitro BCOP Results

Results are shown in Table 6. The corrected mean opacity score was 46.6, and the corrected mean optical density (permeability) score was 1.083. The in vitro score was calculated as 62.85. Histopathologic evaluation revealed corneas treated with Formulation 1 had changes which were considered to be artifacts from handling and not related to the test material.

TABLE 6
Results of in vitro BCOP Test
Individual Control Scores for BCOP

| | | | O.D. |
|---|---|---|---|
| Cornea # | Pretest | 2 hours | Scores |
| C1 | 0 | 0 | 0.015 |
| C2 | 0 | 1 | 0.017 |
| Mean | 0 | 0.5 | 0.016 |

Corrected Mean Opacity Score = 0.5
(=2 hour mean score minus pretest mean score)

Individual Test Scores

| Cor- | | | | | | | | | | | | | |
|---|---|---|---|---|---|---|---|---|---|---|---|---|---|
| nea | | | | | | | | | | | | | O.D. |
| # | Pretest Scores | | | | 3 min Scores | | | | 2 hour Scores | | | | Scores |
| 1 | C1 | −5 | C2 | −4 | C1 | 24 | C2 | 25 | C1 | 44 | C2 | 42 | 0.890 |
| 2 | C1 | −5 | C2 | −4 | C1 | 18 | C2 | 17 | C1 | 35 | C2 | 35 | 1.170 |
| 3 | C1 | −5 | C2 | −4 | C1 | 23 | C2 | 24 | C1 | 48 | C2 | 47 | 0.764 |
| 4 | C1 | −4 | C2 | −4 | C1 | 22 | C2 | 22 | C1 | 47 | C2 | 45 | 1.250 |
| 5 | C1 | −5 | C2 | −5 | C1 | 23 | C2 | 23 | C1 | 43 | C2 | 40 | 1.420 |

Calculated Scores

| | Corrected Opacity Scores | | | | | | | | Corrected |
|---|---|---|---|---|---|---|---|---|---|
| Cornea # | 3 min Scores | | | | 2 hour Scores | | | | O.D. |
| 1 | C1 | 29 | C2 | 29 | C1 | 49 | C2 | 46 | .874 |
| 2 | C1 | 23 | C2 | 21 | C1 | 40 | C2 | 39 | 1.154 |
| 3 | C1 | 28 | C2 | 28 | C1 | 53 | C2 | 51 | 0.748 |
| 4 | C1 | 26 | C2 | 26 | C1 | 51 | C2 | 49 | 1.234 |
| 5 | C1 | 28 | C2 | 28 | C1 | 48 | C2 | 45 | 1.404 |

Corrected Mean Optical Density = 1.083
Corrected Mean Opacity Score = 46.6
(=mean treated opacity score minus corrected mean control opacity score)
Calculated in vitro Score = 46.6 + 15(1.083) = 62.85

The three formulas were tested with a 3 min exposure in the BCOP, according to the recommendations of the BRD. Results from the BCOP at 3 min exposure are shown in Table 7.

TABLE 7
In vitro BCOP 3 Minute Exposure Results
BCOP 3 Minute Exposure Results

| | | In-Vitro | | Perme- |
|---|---|---|---|---|
| Material | MB PROJ # | Score | Cornea | ability |
| Formulation 1 | 09-18658.09 | 62.85 | 46.6 | 1.083 |
| Formulation 2 | 09-18659.09 | 59.33 | 43.1 | 1.082 |
| SPITFIRE ® SC | 09-18660.09 | 84.6 | 65.1 | 1.300 |

The Maximum Average Score of the benchmark in historical Draize testing was 46.7, and all eyes cleared by 14 days. Based on these results, SPITFIRE® SC was classified as Eye Irritation GHS Classification of Category 2A-Severely Irritating to Eyes.

An in vitro score of ≧25<75 should be given a preliminary classification of GHS Category 2A. As such, Formulation 1 and Formulation 2 were preliminarily classified as Eye Irritation GHS Classification Category 2A-Severely Irritating to Eyes. The depth and degree of injury induced by Formulation 1 and Formulation 2 was compared to the depth and degree of injury to that induced by SPITFIRE® SC. As shown in Table 7, SPITFIRE® SC was more irritating in the 3 min exposure study, suggesting Formulation 1 and Formulation 2 were less irritating than SPITFIRE® SC.

Histopathological Evaluation

The compositions were further assessed with a histopathological evaluation and given the final categorization of whichever determination (in vitro score or histological evaluation) was more severe.

Samples included formalin-fixed samples of two control bovine corneas that were exposed to MEM, and 15 bovine corneas that were exposed to Formulation 1 and Formulation 2. Standardized toxicologic pathology criteria and nomenclature for the eyes were used to categorize microscopic tissue changes. The tissues were evaluated without knowledge of the specific pharmacologic activity or formulation of the test articles.

Three representative parallel cross-sections of each cornea, extending from one limbus to the contralateral limbus, were routinely processed, embedded in paraffin, sectioned, and stained with hematoxylin and eosin for microscopic evaluation. In total, there were 51 glass slides with Hematoxylin and Eosin stained bovine eye corneas submitted for the histologic evaluation.

Microscopic examination included the evaluation of the various layers of the corneal epithelium (squamous-cell layer, wing-cell layer, basal-cell layer), basal lamina, Bowman's layer, stroma (substantia propria), Decemet's membrane, and endothelium. The microscopic changes, when present, were graded on a four-scale system ranging from minimal to marked with minimal being the lease detectable change to marked being the most severe change that one could expect to occur in the various areas of the cornea. Corneas without any changes were tabulated as “within normal limits.”

According to BRD interpretation of the histopathological evaluation, the condition of the corneas dosed with SPITFIRE® SC did not indicate corrosiveness, which was consistent with the previous Draize study that classified SPITFIRE® SC as non-corrosive. All changes in the corneas dosed with Formulation 1 and Formulation 2 were considered to be artifacts from handling/dosing and not related to the test material.

Conclusion

Based on the in vitro scores and the histology, as well as the scores for both prototypes being lower than those for SPITFIRE® SC, both Formulation 1 and Formulation 2 were classified as Moderately Irritating to the eyes. Since GHS does not distinguish between a moderate and a severe eye irritant, the classification of Moderately Irritating to the eyes was conservatively equated to GHS Category 2A Irritant. The assay appeared to be more conservative than previous Draize studies, as indicated by the SPITFIRE® SC results, and so it was concluded that the assay was appropriate for conservatively estimating the effects of Formulation 1 and 2 on the eyes.

### Example 8

### Stripping Tests

Formulation 1, BRAVO™ 1500+ and BUTCHERS® CUTTING EDGE™ (both from Diversey, Inc., Sturtevant, Wis.) stripping compositions were tested. Approximately 100 square feet of floor surface was coated with 10 coats of SIGNATURE™ s.8 floor finish. Each stripping composition was diluted 1:4 and applied to the surface in 3 mopdowns. The compositions were allowed to sit on the surface for 10 min dwell time. A TASKI® Auto Scrubber (Diversey, Inc., Sturtevant, Wis.) was passed over the floor surface twice with no water and no vacuum. The autoscrubber was passed once with water and no vacuum. The autoscrubber was passed a final time with water and vacuum but no brush.

Formulation 1 demonstrated initially high foam that dissipated quickly. Virtually no foam was seen in the autoscrubber tank. The wetting was slightly better than BRAVO™ 1500+ and much better than BUTCHERS® CUTTING EDGE™. There was no dry out issue. The odor was much less than that of BRAVO™ 1500+. There was no butyl or ammonia odor. The removal with Formulation 1 was more complete than with BRAVO™ 1500+. No patches of finish were left behind.

BRAVO™ 1500+ had moderate foam without much dissipation. No foam was observed in the autoscrubber tank. The wetting was average; it dried out in 8 min. The odor was slightly strong, and there was a butyl and an ammonia odor. Removal of finish was average, and some spots of finish remained.

BUTCHERS® CUTTING EDGE™ had lower foam than BRAVO™ 1500+. No foam was observed in the autoscrubber tank. The wetting was worse than that for BRAVO™ 1500+; it dried out in 3 min. The odor was stronger than that for BRAVO™ 1500+, and there was a butyl and an ammonia odor. Removal of finish was worse than that for BRAVO™ 1500+, and even more spots of finish remained.

Physical and chemical parameters for some stripping compositions are shown in Table 8. All values shown are for the concentrated composition.

TABLE 8
Physical and Chemical Parameter Analysis
Physical and Chemical Parameter Analysis

| | | free | total | | weight |
|---|---|---|---|---|---|
| | | alkalinity | alkalinity | viscosity | (lbs) per |
| Product | pH | (% Na₂O) | (% Na₂O) | (cps) | gallon |
| Formulation 1 | 11.50 | 3.72 | 5.06 | 5 | 8.83 |
| BRAVO ™ 1500+ | 13.16 | 4.10 | 4.50 | 5 | 8.50 |
| Quicklift | 11.50 | 5.12 | 5.40 | 4 | 8.35 |

Thus, the disclosure provides, among other things, a composition for stripping a coating from a surface. Various features and advantages of the disclosure are set forth in the following claims.

1. A composition suitable for stripping coatings from a surface comprising:
(a) a solvent; and
(b) an organic functional amine,
wherein the composition has a pH of greater than about 10, and
wherein the composition is non-corrosive to eyes or skin.

2. A composition suitable for stripping coatings from a surface comprising:
(a) a solvent; and
(b) an organic functional amine,
wherein the composition has a pH of greater than 11.

3. A composition suitable for stripping coatings from a surface comprising:
(a) a solvent;
(b) an organic functional amine; and
(c) 6-10% chelant.

4. The composition of claim 2, wherein the composition is non-corrosive to eyes or skin.

5. The composition of claim 1, wherein the solvent comprises at least one of an alcohol, an ester, a phthalate-based solvent, a pyrrolidone-based solvent, and combinations thereof.

6. The composition of claim 1, wherein the solvent comprises benzyl alcohol.

7. The composition of claim 1, wherein the composition comprises solvent in an amount of about 1-30% by weight of the composition.

8. The composition of claim 1, wherein the organic functional amine comprises at least one of monoethanolamine, diethanolamine, triethanolamine, monoisopropanolamine, and combinations thereof.

9. The composition of claim 8, wherein the organic functional amine comprises monoethanolamine.

10. The composition of claim 1, wherein the composition comprises organic functional amine in an amount of about 1-25% by weight of the composition.

11. The composition of claim 1, wherein the composition further comprises a buffer.

12. The composition of claim 11, wherein the buffer comprises coco fatty acid.

13. The composition of claim 11, wherein the composition comprises buffer in an amount of about 0.5-10% by weight of the composition.

14. The composition of claim 1, wherein the composition further comprises a chelant.

15. The composition of claim 14, wherein the composition comprises chelant in an amount of about 1-10% by weight of the composition.

16. The composition of claim 15, wherein the composition comprises chelant in an amount of about 6-10%.

17. The composition of claim 14, wherein the chelant comprises EDTA.

18. The composition of claim 1, wherein the composition further comprises glycerin.

19. The composition of claim 1, wherein the composition further comprises propylene glycol.

20. The composition of claim 1, wherein the composition has a Skin Irritation GHS classification of 2 when the composition is tested via OECD Test No. 404.

21. The composition of claim 1, wherein the composition has a Skin Irritation GHS classification of 3 when the composition is tested via OECD Test No. 404.

22. The composition of claim 1, wherein the composition has a Skin Irritation GHS classification of non-classified when the composition is tested via OECD Test No. 404.

23. The composition of claim 1, wherein the composition has an Eye Irritation GHS classification of 2a when the composition is tested via the BCOP Test.

24. The composition of claim 1, wherein the composition has an Eye Irritation GHS classification of 2b when the composition is tested via the BCOP Test.

25. The composition of claim 1, wherein the composition has an Eye Irritation GHS classification of non-classified when the composition is tested via the BCOP Test.

26. The composition of claim 1, wherein the pH is about 11.3-12.

27. A method of removing a coating from a surface, the method comprising applying the composition of claim 1 to the surface in an amount sufficient to remove the coating.

28. A method of stripping a finish at least partially on a surface, the method comprising applying the composition of claim 1 to the finish at least partially on the surface.

29. The composition of claim 3, wherein the composition is non-corrosive to eyes or skin.
